(19) United States
(12) Patent Application Publication
(10) Pub. No.: US 2015/0103259 A1
(43) Pub. Date: Apr. 16, 2015

(54) LIGHTING DEVICE, DISPLAY DEVICE AND TELEVISION DEVICE

(71) Applicant: Sharp Kabushiki Kaisha, Osaka-shi, Osaka (JP)

(72) Inventor: Akira Gotou, Osaka-shi (JP)

(21) Appl. No.: 14/404,074

(22) PCT Filed: Jun. 25, 2013
(86) PCT No.: PCT/JP2013/067320

§ 371 Date: Nov. 26, 2014

(30) Foreign Application Priority Data
Jul. 2, 2012 (JP) 2012-148163

(51) Int. Cl. F21V 29/00; H04N 5/74; G02F 1/1335; F21V 8/00; G02F 1/1333

(52) U.S. Cl. CPC F21V 29/004; G02B 6/005; G02F 1/133308; G02F 1/1336; H04N 5/7408; F21Y 2101/02
USPC 348/790; 362/19; 349/58

(57) ABSTRACT

A backlight device 12 includes LEDs 17, a light guide plate 16, an optical member 15, and a transparent plate 30. The light guide plate 16 includes a front plate surface configured as a light exit surface 16a and opposing side-surfaces configured as light entrance surfaces 16b, 16b. The light entrance surfaces 16b face the respective LEDs 17. The light guide plate 16 is configured to guide light from the LEDs 17 toward the optical member 15. The optical member 15 is arranged adjacent to the light exit surface 16a. The transparent plate 30 having lower thermal conductivity than the light guide plate 16 is arranged between the optical member 15 and at least one edge portion of the light exit surface 16a close to the light entrance surface 16b.

### TECHNICAL FIELD

The present invention relates to a lighting device, a display device, and a television device.

### BACKGROUND ART

Displays in image display devices, such as television devices, are now being shifted from conventional cathode-ray tube displays to thin displays, such as liquid crystal displays and plasma displays. With the thin displays, the thicknesses of the image display devices can be reduced. Liquid crystal panels included in liquid crystal display devices do not emit light, and thus backlight devices are required as separate lighting devices. An edge-light type backlight device including a light guide plate with a light entrance surface on the side and light sources, such as LEDs, arranged facing the light entrance surface is known as an example of such backlight devices.

In a liquid crystal display device including an edge-light type backlight unit, an optical member is arranged between a light exit surface of a light guide plate and a liquid crystal panel. The optical member is a sheet-like member. The optical member is disposed to convert light exiting from the light guide plate into planer light. In the liquid crystal display device including the optical member, heat around light sources may propagate to the optical member via the light guide plate and the optical member may be wrinkled due to heat. If the optical member is wrinkled, uneven brightness may occur in an area of a display surface of the liquid crystal panel where an area of the optical member having wrinkles overlaps. This results in degradation in illumination light, that is, light out of the optical member through the light exit surface. Patent Document 1 discloses an edge-light type backlight device in which wrinkles do not or are less likely to occur on the optical member.

### RELATED ART DOCUMENT

### Patent Document

Patent Document 1: Japanese Unexamined Patent Application Publication No. 2011-216274

### Problem to be Solved by the Invention

In the liquid crystal display device disclosed in Patent Document 1, an optical member is in contact with a light exit surface of a light guide plate. In this configuration, heat around light sources is more likely to propagate to the optical member via the light guide plate. It is difficult to properly remove influence of the heat around the light sources on the optical member. Thus, occurrence of wrinkles on the optical member may not be properly reduced or suppressed.

### DISCLOSURE OF THE PRESENT INVENTION

The technology described herein was made in view of circumstances. An object is to reduce or suppress occurrence of wrinkles on the optical member and to reduce or suppress degradation of illumination light.

### Means for Solving the Problem

Technologies described herein are related to a lighting device having the following configurations. The lighting device includes a light source, a light guide plate, an optical member, and a transparent plate. The light guide plate includes a plate surface configured as a light exit surface and at least a side-surface configured as a light entrance surface. The light entrance surface faces the light source and is configured to guide light from the light source toward the light exit surface. The optical member is arranged adjacent to the light exit surface of the light guide plate. The transparent plate has transparency and has thermal conductivity lower than thermal conductivity of the light guide plate. The transparent plate is arranged between the optical member and at least one edge portion of the light exit surface close to the light entrance surface.

In the above lighting device, the transparent plate is arranged between the light guide plate and the optical member and thus the light guide plate and the optical member are apart from each other. Herein, the temperature of a portion of the light exit surface close to the light entrance surface (i.e., an edge portion close to the side-surface configured as the light entrance surface) tends to increase due to heat around the light source. The transparent plate is arranged between the portion of the light exit surface and the optical member. Further, the thermal conductivity of the transparent plate is lower than that of the light guide plate. Therefore, heat around the light source is less likely to move toward the optical member compared to a configuration in which the light guide plate and the optical member are in contact with each other. The transparent plate has transparency and thus rays of light exiting the light guide plate through the light exit surface are not blocked by the transparent plate. With this configuration, wrinkles do not or are less likely to occur on the optical member due to heat around the light source. Therefore, the quality of illumination, which passes through the light exit surface and exits out the optical member, is not or less likely to be degraded.

The transparent plate may be in contact with the optical member and have rigidity higher than rigidity of the light guide plate.

In this configuration, the transparent plate has higher rigidity than the light guide plate. In comparison to a configuration in which the light guide plate is in contact with the light guide plate, a portion of the optical member that is in contact with the transparent plate is pressed by the transparent plate with a larger force. Even if wrinkles appear on the portion of the optical member, the wrinkles are pressed by the transparent plate and thus the wrinkles are smoothed and removed. Therefore, degradation of illumination is reduced or less likely to occur.

The transparent plate may be in contact with the light exit surface of the light guide plate and have a thermal expansion coefficient lower than a thermal expansion coefficient of the light guide plate.

In this configuration, the transparent plate is less likely to thermally expand compared to the light guide plate. Even if the light guide plate thermally expands toward the optical member, the transparent plate does not thermally expand corresponding to the light guide plate. Namely, if the light guide plate thermally expands toward the optical member, the transparent plate presses a portion of the light exit surface of the light guide plate that is in contact with the transparent plate. Therefore, a portion of the optical member that overlaps the portion of the light exit surface of the light guide plate where the transparent plate contacts is not or less likely to be locally pressed by the light guide plate toward the optical member. With this configuration, portions of the optical member is not or less likely to be pressed by the thermally expanded light guide plate. Therefore, degradation of illumination light is reduced or less likely to occur.

The transparent plate may be arranged between a frame-like portion of the light exit surface including at least an edge area of the light exit surface and the optical member.

In this configuration, the transparent plate overlaps the frame-like portion including the edge area of the light exit surface. Namely, propagation of heat from the light guide plate to the optical member does not or is less likely to occur over a wide range. Heat around the light source does not or is less likely to propagate to the optical member. Thus, wrinkles are further less likely to occur on the optical member due to heat around the light source.

The transparent plate may be arranged between the light exit surface and the optical member for an entire area of the light exit surface.

In this configuration, the transparent plate is arranged in an entire range between the light exit surface of the light guide plate and the optical member. With this configuration, propagation of heat from the light guide plate toward the optical member is effectively reduced or suppressed. Furthermore, the rigidity of the transparent plate is higher than that of the light guide plate and the transparent plate is in contact with the light guide plate. In this configuration, the entire surface of the optical member is pressed by the transparent plate with a larger force. Namely, the wrinkles on the entire surface of the optical member are smoothed by the transparent plate. Therefore, wrinkles are further less likely to occur on the optical member due to heat around the light source.

The lighting device may further include a light source board. The light source may include a plurality of light sources arranged on the light source board. At least a portion of the side-surface may extend to the light source board and may be in contact with a plate surface of the light source board on which the light sources are arranged.

In this configuration, the extension portion that is located between the light source and the optical member is more likely to reduce or suppress the propagation of heat from the light source toward the optical member. Therefore, wrinkles do not or are further less likely to occur on the optical member due to heat around the LEDs.

Technologies described herein are related to a display device having the following configurations. The display device includes including the above lighting device and a display panel and a holding member. The display panel is arranged on an opposite side of the optical member from the transparent plate and configured to display an image using light from the light source. The holding member has a frame-like shape surrounding the optical member. The holding member is arranged between the transparent plate and the display panel and in contact with an edge portion of the transparent plate to hold the transparent plate.

With this configuration, the transparent plate that is held by the holding member is stable and less likely to be shifted. Even if thermal expansion occurs on the display panel side of the transparent plate, the transparent plate is less likely to come close to the optical member. Therefore, the liquid crystal panel is not or less likely to be locally pressed by the light guide plate via the optical member. Thus, the quality of illumination light in the liquid crystal display device 310 is not or less likely to be degraded.

The holding member may have a light blocking property and may be positioned between the light sources and an edge portion of the display panel. The holding member may be in contact with at least a portion of the edge portion on an opposite surface of the display panel from the display surface.

In this configuration, rays of light exiting the light sources and traveling toward an edge surface of the display panel are blocked by the holding member. Namely, the rays of light do not or are less likely to enter the display panel through the edge surface. Therefore, uneven brightness, which may be caused by light entered the display panel through the edge surface, does not or is less likely to occur on a display surface of the display panel.

In the technology disclosed herein, a display device including a liquid crystal panel using liquid crystals as the display panel has novelty and utility. Further, a television device including the above display device has novelty and utility.

### Advantageous Effect of the Invention

According to the technology disclosed herein, wrinkles on the optical member do not or are less likely to occur and illumination light does not or is less likely to degrade.

### BRIEF DESCRIPTION OF THE DRAWINGS

FIG. 1 is an exploded perspective view of a general configuration of a television device TV and a liquid crystal display unit LDU according to a first embodiment.

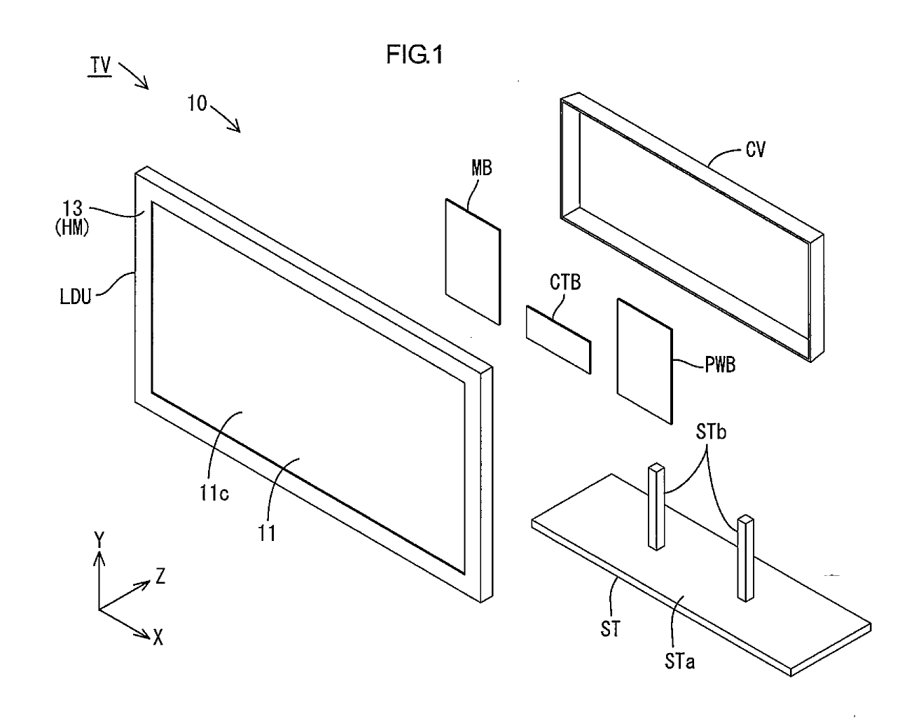

FIG. 2 is a rear view of the television device TV and a liquid crystal display device 10.

FIG. 3 is an exploded perspective view of a general configuration of the liquid crystal display unit LDU of the liquid crystal display device 10.

FIG. 4 is a cross-sectional view of the liquid crystal display device 10 taken along a short-side direction thereof.

FIG. 5 is a cross-sectional view of the liquid crystal display device 10 taken along a long-side direction thereof.

FIG. 6 is a magnified cross-sectional view of one of LED units LU and its vicinity in FIG. 4.

FIG. 7 is a plane sectional view of a transparent plate 30 arranged in a frame 13 viewed from a front side.

FIG. 8 is an exploded perspective view of a general configuration of a liquid crystal display unit LDU of a liquid crystal display device 110 according to a second embodiment.

FIG. 9 is a cross-sectional view of the liquid crystal display device 110 taken along a short-side direction thereof.

FIG. 10 is a plane sectional view of a transparent plate 130 arranged in a frame 113 viewed from a front side.

FIG. 11 is an exploded perspective view of a general configuration of a liquid crystal display unit LDU of a liquid crystal display device 210 according to a third embodiment.

FIG. 12 is a plane sectional view of a transparent plate 230 arranged in a frame 213.

FIG. 13 is a cross-sectional view of a of a liquid crystal display device 310 taken along a short-side direction thereof according to a fourth embodiment.

### MODE FOR CARRYING OUT THE INVENTION

### First Embodiment

A first embodiment will be described with reference to the drawings. A liquid crystal display device (an example of a display device) 10 according to this embodiment will be described. X-axis, Y-axis and Z-axis are indicated in some drawings. The axes in each drawing correspond to the respective axes in other drawings. The Y-axis direction corresponds to a vertical direction and the X-axis direction corresponds to a horizontal direction. An upper side and a lower side are based on the vertical direction unless otherwise specified.

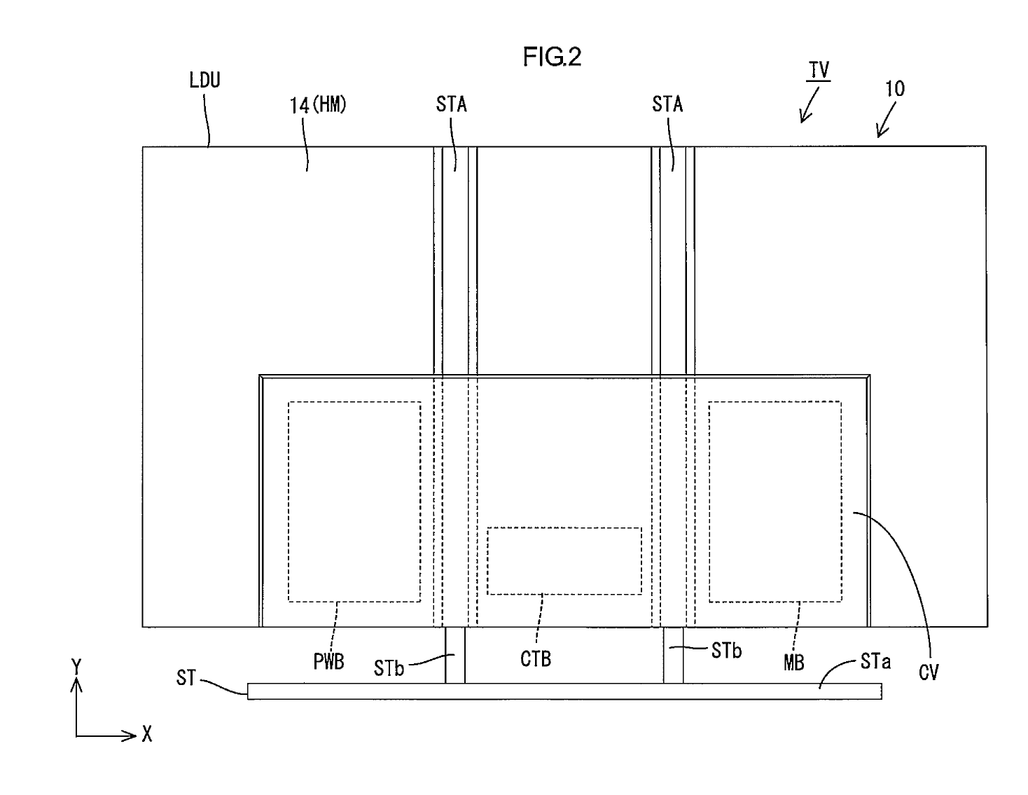

A television device TV includes a liquid crystal display unit LDU, boards PWB, MB, and CTB, a cover CV, and a stand ST. The boards PWB, MB, and CTB are attached to a rear surface (aback surface) of the liquid crystal display unit LDU. The cover CV is attached to the rear surface of the liquid crystal display unit LDU so as to cover the boards PWB, MB, and CTB. The stand ST holds the liquid crystal display unit LDU such that a display surface of the liquid crystal display unit LDU extends in the vertical direction (the Y-axis direction). The liquid crystal display device 10 according to this embodiment has the same configuration as the above-described television device TV except for at least a component for receiving television signals (e.g. a tuner included in a main board MB). As illustrated in FIG. 2, the liquid crystal display unit LDU has a landscape rectangular overall shape (rectangular and longitudinal). The liquid crystal display unit LDU includes a liquid crystal panel 11 as a display panel and a backlight device (an example of a lighting device) 12 as a light source. The liquid crystal panel 11 and the backlight device 12 are collectively held by a frame 13 and a chassis 14. The frame 13 and the chassis 14 are external members that provide an external configuration of the liquid crystal display device 10. The chassis 14 in this embodiment is one of the components to form the exterior and a part of the backlight device 12.

Configurations of the liquid crystal display device 10 on a rear surface side will be described. As illustrated in FIG. 2, stand fitting members STA are attached to a rear surface of the chassis 14 that provides an external configuration of the back of the liquid crystal display device 10. The stand fitting members STA are spaced away from each other in an X-axis direction and extend along the Y-axis direction. Each stand fitting member STA has a cross section that corresponds to a cross section of a channel beam and opens to the chassis 14. A space is provided between the stand fitting member STA and the chassis 14. Support portions STb included in the stand ST are inserted in the respective stand fitting members STA. The space provided in the stand fitting member STA is configured to be a path through which wiring members (e.g. electric wires) which are connected to an LED board (an example of a light source board) 18 are passed. The LED board 18 is included in the backlight device 12. The stand ST includes a base STa and the support portions STb. The base STa extends parallel to the X-Z plane. The support portions STb stand on the base STa in the Y-axis direction. The cover CV is made of synthetic resin and attached to a part of the rear surface of the chassis 14. Specifically, as illustrated in FIG. 2, the cover CV covers a lower half part of the chassis 14 so as to cross over the stand fitting members STA in the X-axis direction. A component storage space is provided between the cover CV and the chassis 14 such that the boards PWB, MB, and CTB, which will be described next, are arranged therein.

As illustrated in FIG. 2, the liquid crystal display device 10 includes a power source board PWB, a main board MB, and a control board CTB as the boards PWB, MB, and CTB. The power source board PWB will be referred to as a power supply of the liquid crystal display device 10 and supplies drive power to the other boards MB and CTB and LEDs (an example of a light source) 17 included in the backlight device 12. Namely, the power source board PWB also serves as “an LED drive board that drives the LEDs 17”. The main board MB includes at least a tuner and an image processor, which are not illustrated. The tuner is configured to receive television signals. The image processor performs image processing on the received television signals. The main board MB is configured to output the processed image signals to the control board CTB, which will be described next. If an external image reproducing device, which is not illustrated, is connected to the liquid crystal display device 10, image signals from the image reproducing device are input to the main board MB. The image processor included in the main board MB processes the image signals, and the main board MB outputs the processed image signals to the control board CTB. The control board CTB is configured to convert the image signals, which is sent from the main board, to driving signals for liquid crystals and to supply the driving signals to the liquid crystal panel 11.

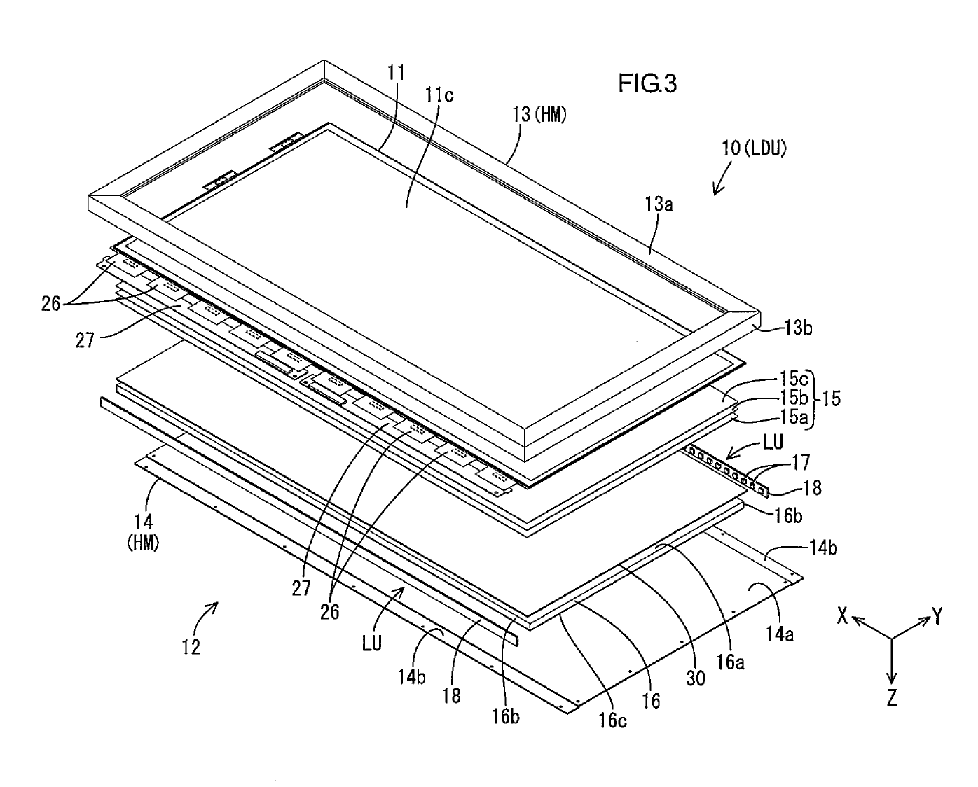

As illustrated in FIG. 3, components of the liquid crystal display unit LDU included in the liquid crystal display device 10 are arranged in a space provided between the frame 13 that provides a front external configuration and the chassis 14 that provides a rear external configuration. The components arranged between the frame 13 and the chassis 14 are at least the liquid crystal panel 11, an optical member 15, a transparent plate 30, a light guide plate 16, and LED units LU. The liquid crystal panel 11, the optical member 15, a transparent plate 30, and the light guide plate 16 are placed on top of one another and held between the frame 13 on the front side and the chassis 14 on the rear side. The backlight device 12 includes the optical member 15, the light guide plate 16, the LED units LU, and the chassis 14. Namely, the liquid crystal display unit LDU without the liquid crystal panel 11 and the frame 13 is the backlight device 12. The LED units LU included in the backlight device 12 are arranged in the space between the frame 13 and the chassis 14. Two LED units LU are each arranged on each end of a short dimension of the light guide plate 16 (in the Y-axis direction). Each LED unit LU includes LEDs 17 as light sources, and the LED board 18. Each component will be described next.

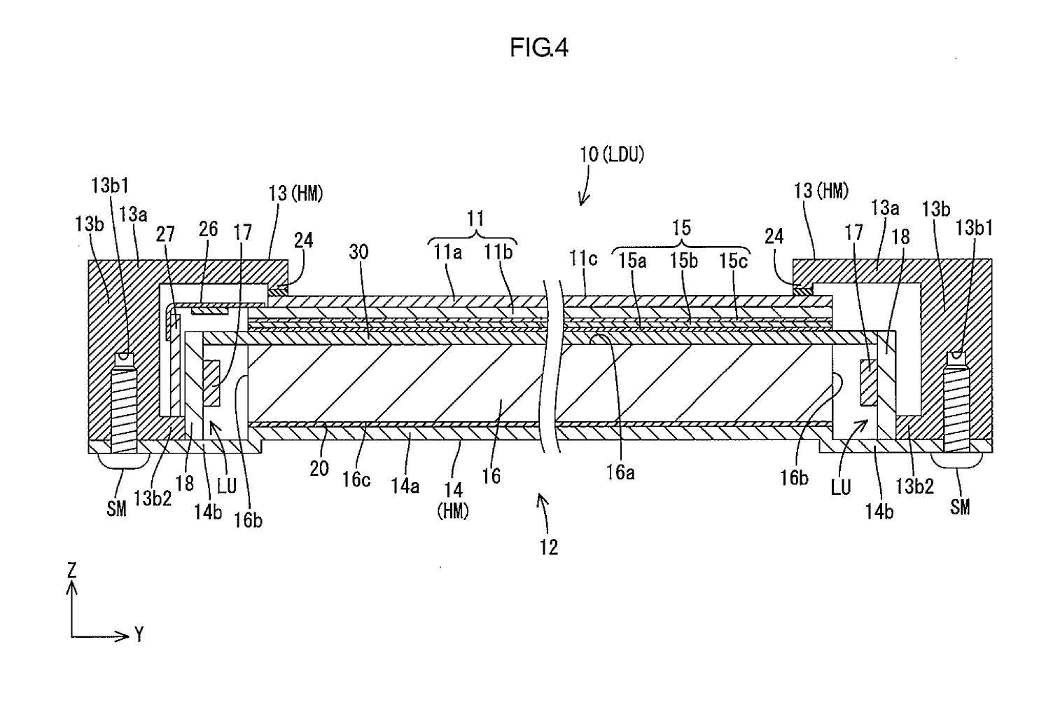

As illustrated in FIG. 3, the liquid crystal panel has a landscape rectangular shape (rectangular and longitudinal) in a plan view and includes a pair of glass substrates 11a and 11b (see FIG. 4) and liquid crystals. The substrates 11a and 11b having high light transmissivity are bonded together with a predetermined gap therebetween. The liquid crystals are sealed between the substrates 11a and 11b. On one of the substrates (an array substrate 11b), switching elements (e.g. TFTs), pixel electrodes, and an alignment film are arranged. The switching elements are connected to gate lines and source lines that are arranged perpendicular to each other. The pixel electrodes are connected to the switching elements. On the other one of the substrates (a CF substrate 11a), color filters, a counter electrode, and an alignment film are arranged. The color filters include red (R), green (G), and blue (B) color portions that are arranged in a predetermined arrangement. The liquid crystal panel 11 is placed on a front side of the optical member 15, which will be described later. A rear-side surface of the liquid crystal panel 11 (an outer-side surface of a polarizing plate on the rear side) is fitted to the optical member 15 with minimal gaps therebetween. Therefore, dust is less likely to enter between the liquid crystal panel 11 and the optical member 15. The liquid crystal panel 11 includes a display surface 11c. The display surface 11c includes a display area and a non-display area. The display area is an inner area of a screen in which images are displayed. The non-display area is an outer area of the screen around the display area with a frame-like shape. The liquid crystal panel 11 is connected to the control board CTB via a driver for driving the liquid crystals and flexible boards 26. The liquid crystal panel 11 displays an image in the display area of the display surface 11c based on signals sent from the control board CTB. The polarizing plates, which are not illustrated, are arranged on outer sides of the substrates 11a and 11b.

As illustrated in FIG. 3, similar to the liquid crystal panel 11, the optical member 15 has a landscape rectangular shape in a plan view and has the same size (i.e., a short dimension and a long dimension) as the liquid crystal panel 11. The optical member 15 is placed on a front surface of the transparent plate 30, which will be described later, and sandwiched between the transparent plate 30 and the liquid crystal panel 11. The optical member 15 includes three sheets that are placed on top of one another. Specifically, a diffuser sheet 15a, a lens sheet (a prism sheet) 15b, and a reflecting type polarizing sheet 15c are placed on top of one another in this sequence from the rear side (the light guide plate 16 side). Each of the three sheets 15a, 15b, and 15c has the substantially same size in a plan view.

The light guide plate 16 is made of substantially transparent (high transmissivity) synthetic resin (e.g. acrylic resin or polycarbonate such as PMMA) which has a refractive index considerably higher than that of the air. As illustrated in FIG. 3, the light guide plate 16 has a landscape rectangular shape in a plan view similar to the liquid crystal panel 11, the optical member 15, and the transparent plate 30. A thickness of the light guide plate 16 is larger than thicknesses of the optical member 15 and the transparent plate 30. A long-side direction and a short-side direction of a main surface of the light guide plate 16 correspond to the X-axis direction and the Y-axis direction, respectively. A thickness direction of the light guide plate 16 that is perpendicular to the main surface of the light guide plate 16 corresponds to the Z-axis direction. The light guide plate 16 is arranged on a rear side of the transparent plate 30 and sandwiched between the transparent plate 30 and the chassis 14. As illustrated in FIG. 4, at least a short dimension of the light guide plate 16 is larger than those of the liquid crystal panel 11, the transparent plate 30, and the optical member 15. The light guide plate 16 is arranged such that ends of the short dimension thereof (i.e., end surfaces along long-sides of the light guide plate 16) are aligned with respective ends of the liquid crystal panel 11 and the optical member 15 (so as to overlap in a plan view). The LED units LU are arranged on sides of the short dimension of the light guide plate 16 so as to have the light guide plate 16 between the LED units LU in the Y-axis direction. Light from the LEDs 17 enters the light guide plate 16 through the ends of the short dimension of the light guide plate 16. The light guide plate 16 is configured to guide the light, which is from the LEDs 17 and enters the light guide plate 16 through the ends of the short dimension, toward the optical member 15 (on the front side). The backlight device 12 according to this embodiment is so-called an edge-type backlight unit (or side-light type backlight unit), and the LEDs 17 as light sources are arranged so as to face the side-surface of the light guide plate 16. In this configuration, light passing through the light guide plate 16 is guided to the liquid crystal panel 11.

One of the main surfaces of the light guide plate 16 facing the front side (a surface opposite the optical member 15) is a light exit surface 16a. Light exits the light guide plate 16 through the light exit surface 16a toward the transparent plate 30, the optical member 15, and the liquid crystal panel 11. The light guide plate 16 includes outer peripheral surfaces that are adjacent to the main surfaces of the light guide plate 16, and long-side peripheral end surfaces (end surfaces of the short dimension) which have elongated shapes along the X-axis direction are opposite the respective LEDs 17 (the LED boards 18). A predetermined space is provided between each long-side peripheral end surface and the LEDs 17 (the LED boards 18). The long peripheral end surface is a light entrance surfaces 16b through which light from LEDs 17 enters. As illustrated in FIG. 4, a reflection sheet 20 is arranged on the rear side of the light guide plate 16, i.e., on an opposed surface 16c that is a plate surface opposite from the light exit surface 16a (a surface opposite the chassis 14). The reflection sheet 20 is arranged to cover an entire area of the opposed surface 16c.

The reflection sheet 20 is arranged so as to be sandwiched between the chassis 14 and the light guide plate 16. Light that exits the light guide plate 16 through the opposed surface 16c toward the rear side is reflected by the reflection sheet 20 toward the front side. The reflection sheet 20 is made of synthetic resin and has a white surface having high light reflectivity. A short-side dimension of the reflection sheet 20 is the same as that of the light guide plate 16.

Next, configurations of the LEDs 17 and the LED board 18 included in the LED unit LU will be described. Each LED 17, which is included in the LED unit LU, includes an LED chip (not illustrated). The LED chip is arranged on a board that is fixed on the LED board 18 and sealed with resin. The LED chip mounted on the board has one main light emission wavelength. The LED chip mounted on the board has one main light emission wavelength. Specifically, the LED chip that emits light in a single color of blue is used. The resin that seals the LED chip contains phosphors dispersed therein. The phosphors emit light in a predetermined color when excited by blue light emitted from the LED chip. Thus, overall color of light emitted from the LED 17 is white. The phosphors may be selected, as appropriate, from yellow phosphors that emit yellow light, green phosphors that emit green light, and red phosphors that emit red light. The phosphors may be used in combination of the above phosphors. The LED 17 includes a main light-emitting surface that is opposite from a mount surface 18a of the LED board 18 (i.e., a surface facing the light entrance surface 16b of the light guide plate 16). Namely, the LED 17 is a top-surface-emitting type LED.

As illustrated in FIG. 3, each LED board 18 included in the LED unit LU has an elongated plate-like shape and extends in the long-side direction of the light guide plate 16 (the X-axis direction, the long-side direction of the light entrance surface 16b). The LED boards 18 are arranged in a space between the frame 13 and the chassis 14 such that a plate surface of each LED board 18 is parallel to the X-Z plane, that is, parallel to the light entrance surface 16b of the light guide plate 16. Each LED board 18 has a long-side dimension that is about a half of the long-side dimension of the light guide plate 16. The LED board 18 includes the mount surface 18a on which the LEDs 17 are surface-mounted. The mount surface 18a is a plate surface that faces inward, namely, a plate surface that faces the light guide plate 16 (the surface opposite the light guide plate 16). The LEDs 17 are arranged in a line (i.e., linearly) at intervals on the mount surface 18a of the LED board 18 along the long-side direction of the LED board 18 (the X-axis direction). In other words, multiple LEDs 17 are arranged apart from each other along long-side ends of the backlight device 12. Distances between the adjacent LEDs 17 in the X-axis direction are substantially equal, that is, the LEDs 17 are arranged at substantially equal intervals. An arrangement direction of the LEDs 17 corresponds to the longitudinal direction of the LED board 18 (the X-axis direction). A Metal-film trace (not illustrated), such as copper-foil trace, is formed on the mount surface 18a of the LED board 18. The metal-film trace extends in the X-axis direction and crosses over a group of the LEDs 17 so as to connect the adjacent LEDs 17 in series. Terminals at ends of the trace are electrically connected to the power source board PWB via wiring members including connectors and electric wires. Thus, driving power is supplied to the LEDs 17. The LED board 18 includes board through holes 18s along the long-side direction of the LED board 18 (the X-axis direction). Each board through hole 18s has a round opening and extends through the LED board 18 in a thickness direction of the LED board 18 (the Y-axis direction). The fixing screws 40, which will be described later, are inserted in the respective board through holes 18s.

Next, configurations of the frame 13 and the chassis 14 that constitute the exteriors and a holding member HM will be described. The frame 13 and the chassis 14 are made of metal such as aluminum. Therefore, the mechanical strength (rigidity) and thermal conductivity of the frame 13 and the chassis 14 are higher than those of a frame and a chassis made of synthetic resin. As illustrated in FIG. 3, the frame 13 and the chassis 14 hold the LED units LU at ends of the short dimension of the frame 13 and the chassis 14 (at the respective long sides). The frame 13 and the chassis 14 hold the liquid crystal panel 11, the optical member 15, the transparent plate 30, and the light guide plate 16, which are placed on top of the other, from the front side and the rear side.

As illustrated in FIG. 3, the frame 13 has a landscape rectangular shape so as to surround the display area in the display surface 11c of the liquid crystal panel 11. The frame 13 includes a panel holding portion 13a and side walls 13b. The panel holding portion 13a is parallel to the display surface 11c of the liquid crystal panel 11 and presses the liquid crystal panel 11 from the front side. Each of the side walls 13b protrudes from an outer peripheral portion of the panel holding portion 13a toward the rear side. The panel holding portion 13a and each side wall 13b form an L-like shape in a cross section. The panel holding portion 13a has a landscape-rectangular and frame-like shape that corresponds to an outer portion of the liquid crystal panel 11 (i.e., the non-display area or a frame-like portion). The panel holding portion 13a presses a substantially entire area of the outer portion of the liquid crystal panel 11 from the front side. The panel holding portion 13a has a width that is large enough to cover not only the outer portion of the liquid crystal panel 11 but also an outer portion of each of the optical member 15, the transparent plate 30, and the light guide plate 16, and LED units LU from the front side. The outer portions of the optical member 15, the transparent plate 30, and the light guide plate 16 and the LED units LU are located on the outer side with respect to the outer portion of the liquid crystal panel 11 in a radiation direction. Similar to the display surface 11c of the liquid crystal panel 11, a front exterior surface of the panel holding portion 13a (an opposed surface from the surface facing the liquid crystal panel 11) is seen from the front side of the liquid crystal display device 10. The panel holding portion 13a constitutes a front exterior of the liquid crystal display device 10 together with the display surface 11c of the liquid crystal panel 11. The side walls 13b form a substantially rectangular hollow shape and protrude from the respective outer peripheral portions (specifically, an outer end portions) of the panel holding portion 13a toward the rear side. The frame 13 includes two long frame pieces that constitute long portions of the frame 13 and two short frame pieces that constitute short portions of the frame 13. The frame pieces include the side walls 13b. A width of the side wall 13b of the long frame piece is different from a width of the side wall 13b of the short frame pieces. Specifically, the side wall 13b of the long frame piece has a larger width than the side wall 13b of the short frame piece. The side walls 13b entirely surrounds the liquid crystal panel 11, the optical member 15, the transparent plate 30, the light guide plate 16, and the LED units LU, which are arranged in the space between the frame 13 and the chassis 14. An outer surface of each side wall 13b that extends along an outer peripheral surface of the liquid crystal display device 10 is seen from the outside of the liquid crystal display device 10. Therefore, the outer surfaces of the side walls 13b constitute a top surface, a bottom surface, and side surfaces of the liquid crystal display device 10.

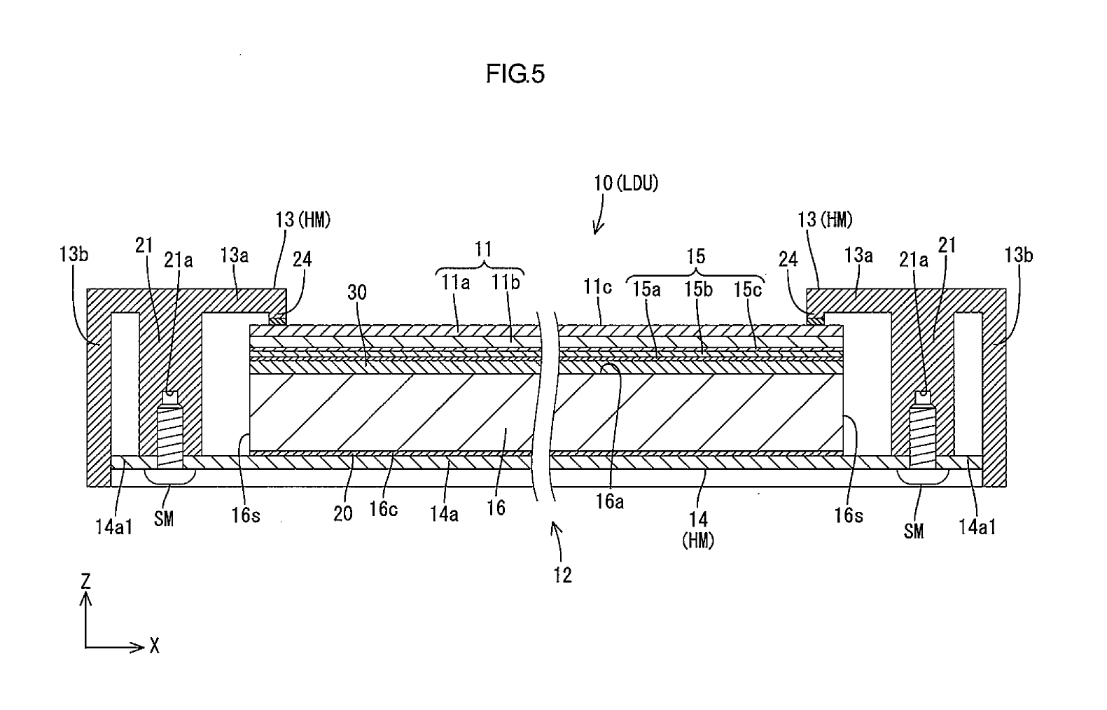

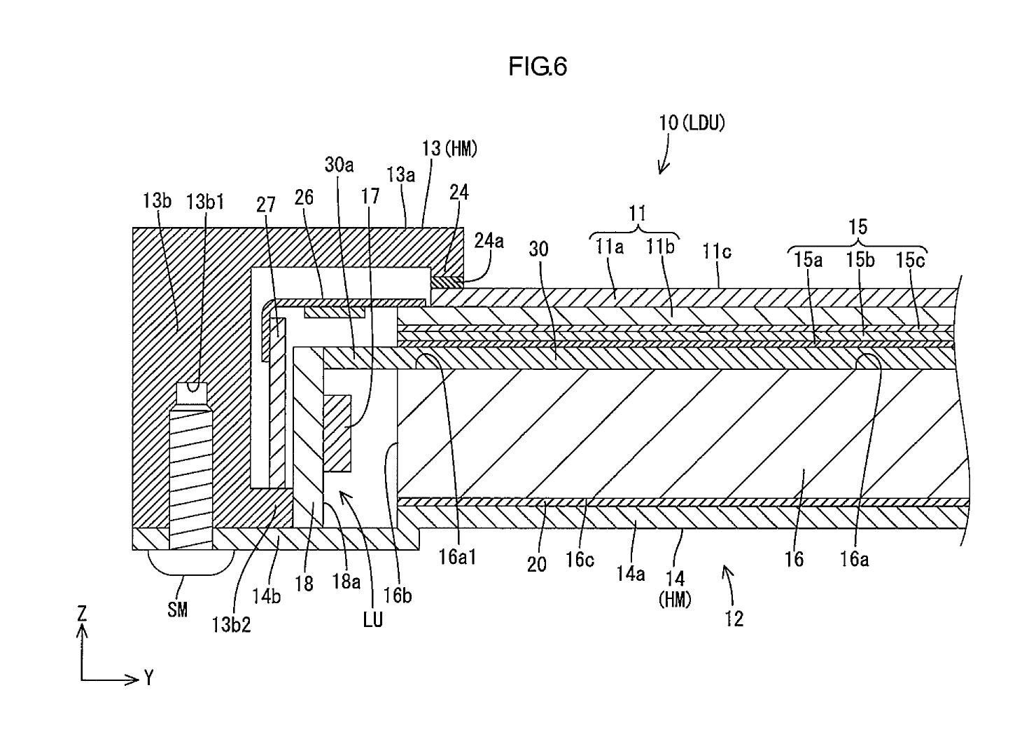

As illustrated in FIGS. 4 and 5, the panel holding portion 13a includes a holding protrusion 24 as a part thereof. The holding protrusion 24 protrudes from an inner edge of the panel holding portion 13a toward the rear-surface side, that is, toward the liquid crystal panel 11. The holding protrusion 24 includes a shock absorber 24a (see FIG. 6) at its protruded end. The holding protrusion 24 presses the liquid crystal panel 11 from the front side via the shock absorber 24a in between. The frame pieces that constitute the frame 13 include the shock absorbers 24a, each of which extends along the side of each frame piece. When the frame pieces are attached together, the shock absorbers 24a form frame-like shape as a whole along the inner peripheral surfaces of the panel holding portion 13a over the entire length.

As illustrated in FIG. 4, the short frame pieces that constitute the short portions of the frame 13 include screw mounting portions 21 as a part thereof. Each of the screw mounting portions 21 is located on an interior side of the side wall 13b (a position close to the light guide plate 16). Screw members SM are mounted to the screw mounting portions 21. The screw mounting portion 21 protrudes from an inner surface of the panel holding portion 13a in the Z-axis direction toward the rear side and has an elongated block-like shape that extends along each side of the panel holding portion 13a (in the X-axis direction or the Y-axis direction). As illustrated in FIG. 5, the screw mounting portion 21 includes recesses 21a that open to the rear side. The screw members SM are screwed in the recesses 21a.

The side walls 13b are in contact with surfaces of outer peripheral portions of the rear chassis 14 while the side walls 13b surround the liquid crystal panel 11, the optical member 15, the light guide plate 16, and the LED units LU, which are arranged in the space between the frame 13 and the chassis 14. An outer surface of each side wall 13b that extends along an outer peripheral surface of the liquid crystal display device 10 is seen from the outside of the liquid crystal display device 10. Therefore, the outer surfaces of the side walls 13b constitute a top surface, a bottom surface, and side surfaces of the liquid crystal display device 10. The side wall 13b protrudes from an outer peripheral portion of the panel holding portion 13a in the Z-axis direction toward the rear side. The side wall 13b has an elongated block-like shape that extends along the corresponding side of the panel holding portion 13a (in the X-axis direction or the Y-axis direction). A distal end of the side wall 13b is in contact with an outer end portion of a second bottom-plate portion 14b of the chassis 14, which will be described later.

As illustrated in FIG. 4, the screw members SM are mounted to the side walls 13b of the long frame pieces that constitute the long portions of the frame 13 (the side walls 13b included in the long frame pieces will be hereinafter referred to as longer side walls 13b). As illustrated in FIG. 4, each longer side wall 13b includes the recesses 13b1 that open to the rear side. The screw members SM are screwed in the respective recesses 13b1. The longer side wall 13b includes a board attachment portion 13b2. The board attachment portion 13b2 slightly extends from a rear end of the side wall 13b toward the inner side. An extended distal end surface of the board attachment portion 13b2 is attached to a plate surface of the LED board 18 opposite from the mount surface 18a. With the mount surface 18a parallel to the light entrance surface 16b of the light guide plate 16, the LED board 18 is held on the chassis 14.

As illustrated in FIG. 4, a predetermined gap is provided between the longer side wall 13b and the corresponding LED board 18. Printed circuit boards 27 are arranged in the gap. Each of the printed circuit boards 27 includes the flexible boards 26 that are arranged at intervals in a long-side direction of the printed circuit board 27. The flexible boards 26 are connected to the printed circuit board 27 at the other end thereof. The printed circuit board 27 includes a connector (not illustrated) to which an end of an FPC (not illustrated) is connected. The other end of the FPC extends to the rear side of the chassis 14 through an FPC hole (not illustrated) in the chassis 14 and is connected to the control board CTB.

As illustrated in FIG. 3, the chassis 14 has a substantially longitudinal shallow tray shape as a whole and covers entire areas of the light guide plate 16 and the LED unit LU from the rear side. A rear outer surface of the chassis 14 (a surface of the chassis 14 opposite from a surface that faces the LED unit LU) is seen from the rear side and constitutes a back surface of the liquid crystal display device 10. The chassis 14 includes a first bottom-plate portion 14a and two second bottom-plate portions 14b. The first bottom-plate portion 14a has a landscape rectangular shape similar to the light guide plate 16. Each of second bottom-plate portions 14b is a step-like portion that protrudes from a corresponding long edge of the first bottom-plate portion 14a toward the rear side. The LED units LU are arranged in the respective second bottom-plate portions 14b.

As illustrated in FIGS. 3 and 4, the first bottom-plate portion 14a has a flat plate shape to receive a short-side portion of the light guide plate 16 from the rear side. The first bottom-plate portion 14a may be referred to as a light guide plate receiving portion. As illustrated in FIG. 5, ends of a long dimension of the first bottom-plate portion 14a extend over the ends of the long dimension of the light guide plate 16. The ends of the long dimension of the first bottom-plate portion 14a are portions to which the screw members SM are mounted from the rear side. The screw members SM are for fixing the frame 13 and the chassis 14 in a mounted state. The ends of the long dimension of the first bottom-plate portion 14a (i.e. the X-axis direction) are in contact with respective inner surfaces of the side walls 13b. With this configuration, the position of chassis 14 relative to the X-axis direction is fixed with respect to the frame 13.

As illustrated in FIGS. 3 and 4, the second bottom-plate portion 14b is recessed from the first bottom-plate portion 14a toward the rear side to provide a space p for holding the LED unit LU therein. The second bottom-plate portion 14b is parallel to the first bottom-plate portion 14a. The LED unit LU is arranged perpendicular to an inner surface of the second bottom-plate portion 14b. As described above, the distal end of the longer side wall 13b is in contact with the peripheral end portion of the inner surface of the second bottom-plate portion 14b. The screw members SM are mounted to the outer end portion of the second bottom-plate portion 14b from the rear side.

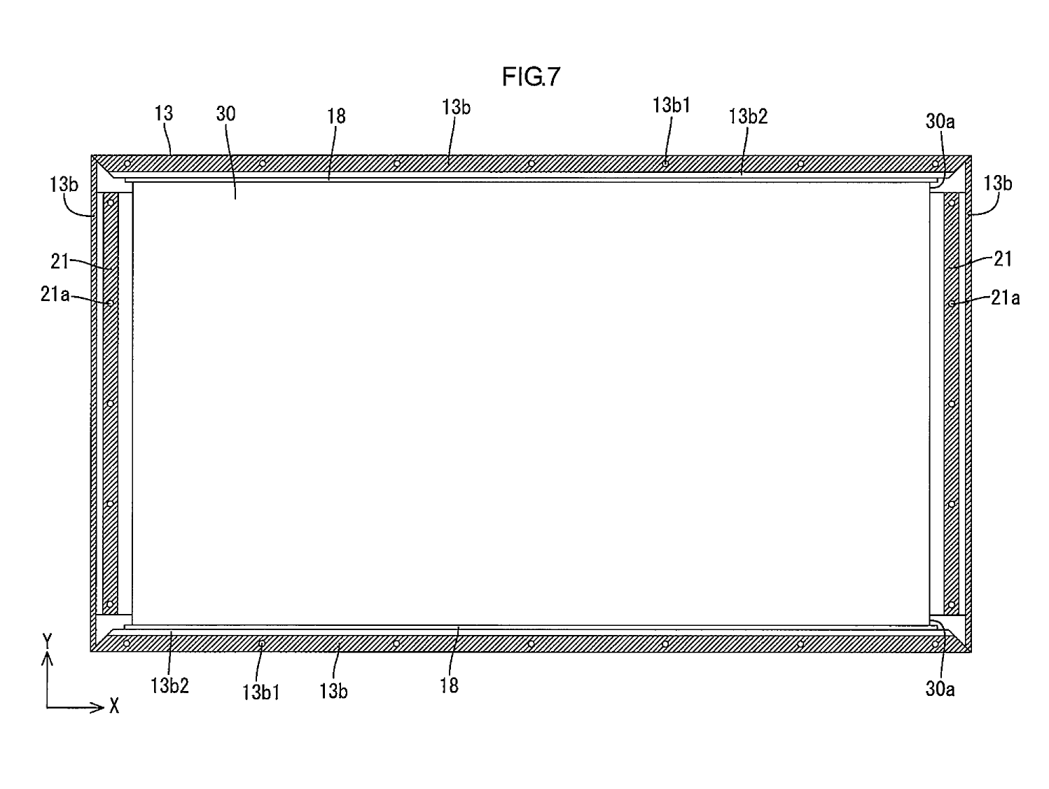

Next, configurations and functions of the transparent plate 30 of this embodiment will be described. The transparent plate 30 is made of substantially transparent material having high light transmissivity and a refractive index considerably higher than that of the air (e.g. glass). The material of the transparent plate 30 is different from that of the light guide plate 16. Specifically, the transparent plate 30 has lower thermal conductivity, higher rigidity, and a lower thermal expansion coefficient than the light guide plate 16. As illustrated in FIG. 3, the transparent plate 30 is a plate having a longitudinal rectangular shape in a plan view, similar to the liquid crystal panel 11, the optical member 15, and the light guide plate 16. A thickness of the transparent plate 30 is smaller than that of the light guide plate 16. Similar to the light guide plate 16, a long-side direction and a short-side direction of a main surface of the transparent plate 30 are aligned with the X-axis direction and the Y-axis direction, respectively. A thickness of the transparent plate 30 is perpendicular to the main surface of the transparent plate 30 and aligned with the Z-axis direction. The transparent plate 30 is layered on a front surface of the light guide plate 16, which is the light exit surface 16a, and sandwiched between the light guide plate 16 and the optical member 15. The transparent plate 30 has a rear surface that is in contact with an entire area of the light exit surface 16a of the light guide plate 16 (see FIG. 7). A front surface of the transparent plate 30 is in contact with an entire area of a rear surface of the optical member 15. In such an arrangement of the transparent plate 30, the light exit surface 16b of the light guide plate 16 and the optical member 15 are apart from each other. The transparent plate 30 has transparency similar to the light guide plate 16. Therefore, rays of light exiting the light guide plate 16 through the light exit surface 16a and directing toward the optical member 15 and the liquid crystal panel 11 are less likely to be blocked by the transparent plate 30.

As illustrated in FIG. 4, the transparent plate 30 has a short dimension (the Y-axis direction) which is larger than a short dimension of the optical member 15 and a short dimension of the light guide plate 16. Each end of the short dimension of the transparent plate 30 (longitudinal side-surfaces) extends over a short end of the optical member 15 and a short end of the light guide plate 16 (i.e., extends over the light entrance surface 16b). The extended portion of the transparent plate 30 is hereinafter referred to as an extension portion 30a. The extension portion 30a extends to the corresponding LED board 18, and a distal end thereof is in contact with the mount surface 18a of the corresponding LED board 18. Namely, the extension portion 30a of the transparent plate 30 is located between the LEDs 17 and the optical member 15. In this configuration, direct propagation of heat from the LEDs 17 to the optical member 15 does not or is less likely to occur. Even if the LED board 18 warps due to heat, warping of the LED board 18 toward the light entrance surface 16b is restricted by the extension portion 30a. Therefore, a distance between the LEDs 17 and the light entrance surface 16b is maintained constant.

In the backlight device 12, the transparent plate 30 is arranged on the light exit surface 16b of the light guide plate 16. Namely, the transparent plate 30 is located between the optical member 15 and at least an edge portion 16a1 of the light exit surface 16b1 close to the light entrance surface 16b. Heat around the LEDs 17 propagates to the light entrance surface 16b of the light guide plate 16, and increases the temperature around the light entrance surface 16b of the light guide plate 16. In this embodiment, the transparent plate 30 is arranged as described earlier and thus the light exit surface 16a and the optical member 15 are apart from each other. The transparent plate 30 has lower thermal conductivity than the light guide plate 16. Therefore, heat accumulated around the light entrance surface 16b does not or is less likely to propagate from the edge portion of the light exit surface 16a close to the light entrance surface 16b toward the optical member 15. Namely, heat does not or is less likely to propagate to the optical member 15. The transparent plate 15 is in contact with an entire surface of the light exit surface 16b of the light guide plate 16. Therefore, even if temperatures increase in portions of the light guide plate 16 other than the portion around the light entrance surface 16b, propagation of heat from the light exit surface 16a to the optical member 15 is reduced or suppressed by the transparent plate 30.

The transparent plate 30 has rigidity higher than that of the light guide plate 16. In comparison to a configuration in which the optical member 15 is arranged so as to be in contact with the light exit surface 16b of the light guide plate 16, the entire rear surface of the optical member 15 is pressed by the transparent plate 30 with a larger force. With such a larger force, wrinkles on the optical member 15 are smoothed and reduced. The transparent plate 30 has a thermal expansion coefficient lower than that of the light guide plate 16. Namely, a thermal expansion variation of the transparent plate 30 is smaller than that of the light guide plate 16. If the optical member 15 is in contact with the light guide plate 16, portions of the optical member 15 may be pressed by the light guide plate 16 when the light guide plate 16 thermally expands toward the optical member 15. In this embodiment, the transparent plate 30, the thermal expansion variation of which is smaller than that of the light guide plate 16, is arranged between the light guide plate 16 and the optical member 15. Therefore, even if the light guide plate 16 thermally expands toward the optical member 15, a local pressure is not or less likely to be exerted on the optical member 15. Wrinkles due to the local pressure on the optical member 15 do not or are less likely to appear on the portions of the optical member 15.

As described earlier, in the backlight device 12 according to this embodiment, the transparent plate 30 is arranged between the light guide plate 16 and the optical member 15. Thus, the light guide plate 16 and the optical member 15 are apart from each other. In a portion of the light exit surface 16b close to the light entrance surface 16b (i.e. the edge portion close to a side surface configured as the light entrance surface 16b), the temperature tends to increase due to heat around the LEDs 17. In this embodiment, the transparent plate 30 is arranged between the optical member 15 and the portion of the light exit surface 16a close to the light entrance surface 16b. Further, the transparent plate 30 has lower thermal conductivity than the light guide plate 16. Therefore, heat around the LEDs 17 is less likely to propagate to the optical member 15 compared to a configuration in which the light guide plate 16 and the optical member 15 are in contact with each other. The transparent plate 30 has transparency. Therefore, rays of light exiting the light guide plate 16 through the light exit surface 16b are less likely to be blocked by the transparent plate 30. With the configurations, because the optical member 15 does not or is less likely to wrinkle due to heat around the LEDs 17, quality of illumination light, that is, light out of the optical member 15 through the light exit surface 16a is not or less likely to be degraded.

In the backlight device 12 according to this embodiment, the transparent plate 30 is in contact with the optical member 15 and has rigidity higher than that of the light guide plate 16. In comparison to a configuration in which the light guide plate 16 is in contact with the optical member 15, a portion of the optical member 15 that is in contact with the transparent plate 30 is pressed by the transparent plate 30 with a larger force. Even if wrinkles appear on the portion of the optical member 15 that is in contact with the transparent plate 30, the wrinkles are pressed by the transparent plate 30 and thus smoothed out and removed. Therefore, degradation of illumination light is reduced or less likely to occur.

In the backlight device 12 according to this embodiment, the transparent plate 30 is in contact with the light exit surface 16a of the light guide plate 16 and has the thermal expansion coefficient lower than that of the light guide plate 16. Namely, the transparent plate 30 is less likely to thermally expand compared to the light guide plate 16. Even if the light guide plate 16 thermally expands toward the optical member 15, the transparent plate 30 does not thermally expand corresponding to the light guide plate 16. When the light guide plate 16 thermally expands toward the optical member 15, a portion of the light exit surface 16a of the light guide plate 16 where the transparent plate 30 contacts is pressed by the transparent plate 30. Namely, a portion of the transparent plate 30 that overlaps a portion of the optical member 15 in contact with the transparent plate 30 is not or less likely to be pressed by the light guide plate 16 toward the optical member 15. With this configuration, portions of the optical member 15 are not or less likely to be pressed by the thermally expanded light guide plate 16 Therefore, degradation of illumination light is reduced or less likely to occur.

In the backlight device 12 according to this embodiment, the transparent plate 30 is arranged between the light exit surface 16a and the optical member 15 for the entire area of the light exit surface 16a. Namely, the transparent plate 30 is arranged over an entire range between the light exit surface 16a of the light guide plate 16 and the optical member 15. With this configuration, propagation of heat from the light guide plate toward the optical member 15 is effectively reduced or suppressed. Furthermore, the rigidity of the transparent plate 30 is higher than that of the light guide plate 16, and the transparent plate 30 is in contact with the light guide plate 16. In this configuration, the entire surface of the optical member 15 is pressed by the transparent plate 30 with a larger force. Namely, the wrinkles on the optical member 15 can be smoothed over the entire surface. Therefore, wrinkles do not or are further less likely to occur on the optical member 15 due to heat around the LEDs 17.

In the backlight device 12 according to this embodiment, the transparent plate 30 includes the extension portions 30a on the respective long end portions thereof. Each extension portion 30a extends over the light entrance surface 16b toward the corresponding LED board 18. The extension portion 30a is in contact with the mount surface 18a of the LED board 18. In this configuration, because the extension portion 30a is located between the LEDs 17 and the optical member 15, propagation of heat from the LEDs 17 toward the optical member 15 is further reduced or suppressed. Therefore, the optical member 15 is not or further less likely to be wrinkled due to heat around the LEDs 17.

### Second Embodiment

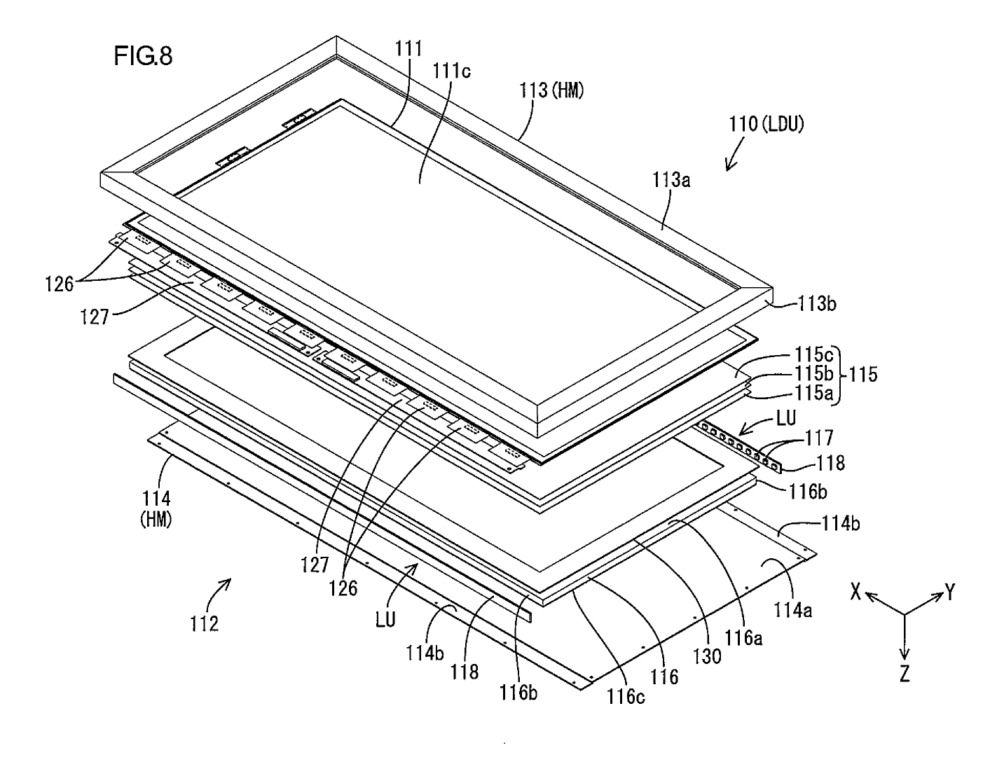

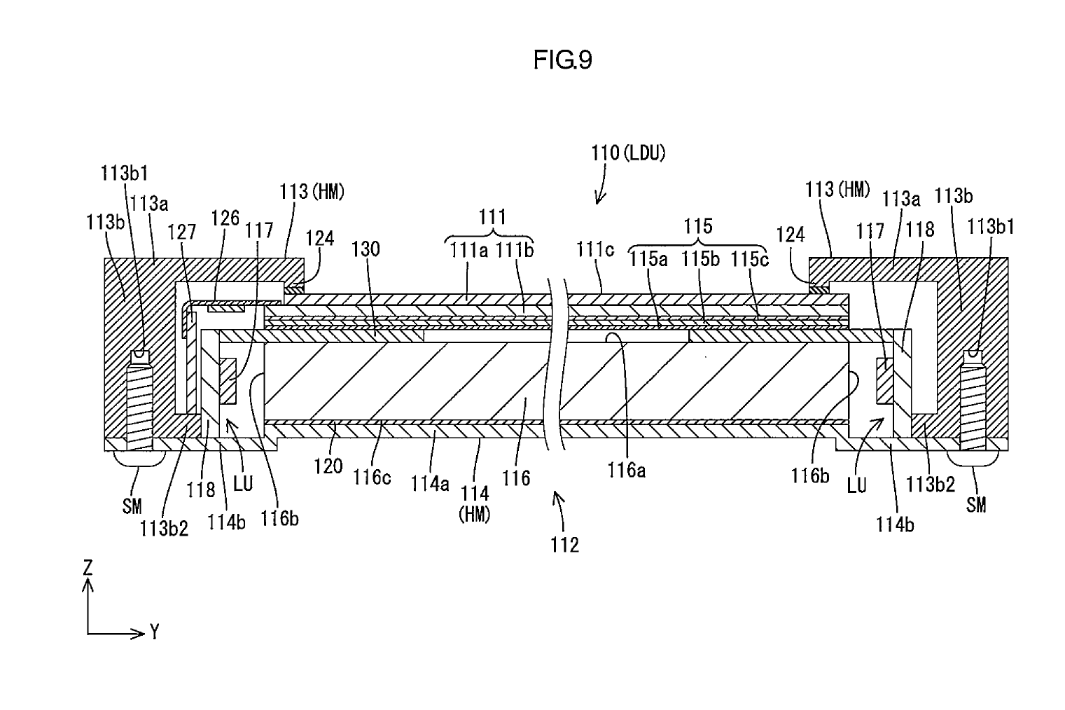

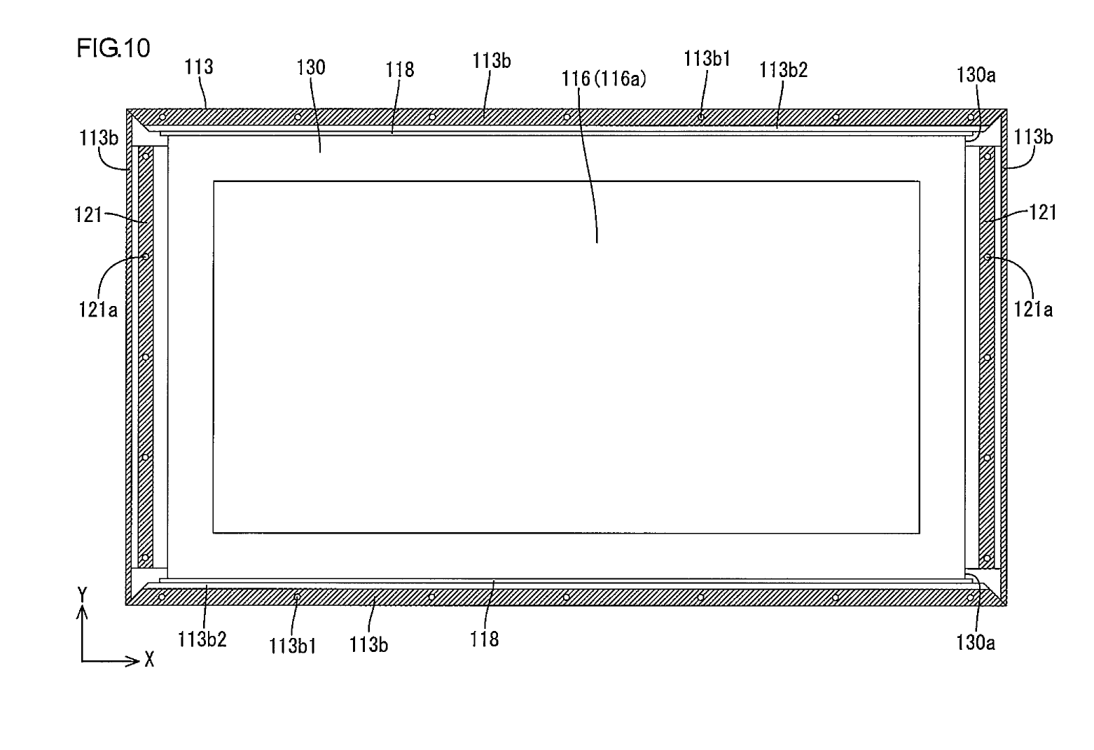

A second embodiment will be described with reference to the drawings. The second embodiment includes a transparent plate 130 having a shape different from the first embodiment. Other configurations are similar to the first embodiment and thus configurations, functions, and effects of those will not be described. In FIGS. 8, 9, and 10, portions indicated by numerals including the reference numerals in FIGS. 3, 4, and 7, respectively, with 100 added thereto have the same configurations as the portions indicated by the respective reference numerals in the first embodiment.

As illustrated in FIGS. 8 to 10, a backlight device 112 according to the second embodiment includes the transparent plate 130 having a frame-like shape. The transparent plate 130 in the frame-like shape is in contact with a frame-like portion of a light exit surface 116a. The frame-like portion of the light exit surface 116a includes at least an edge area of the light exit surface 116a. Namely, the transparent plate 130 is arranged between an optical member 115 and at least one edge portion of the light exit surface 116a close to a light entrance surface 116b. Even in this configuration, a light guide plate 116 and the optical member 115 are apart from each other with the transparent plate 130 therebetween. The transparent plate 130 has thermal conductivity lower than that of the light guide plate 116. Namely, heat around LEDs 117 is less likely to propagate to the optical member 115 compared to a configuration in which the light guide plate 116 is in contact with the optical member 115. With this configuration, the optical member 115 is not or less likely to be wrinkled due to heat around the LEDs 117. Therefore, the quality of illumination light, that is, light out of the optical member 115 through the light exit surface 116a, is not or less likely to be degraded.

### Third Embodiment

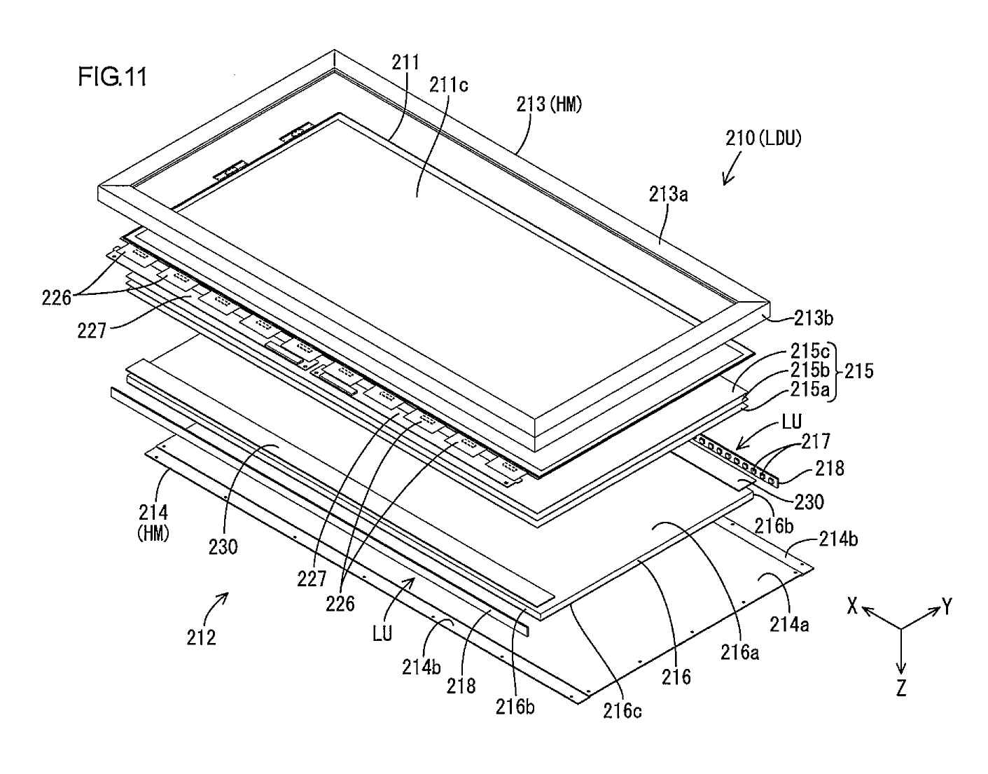

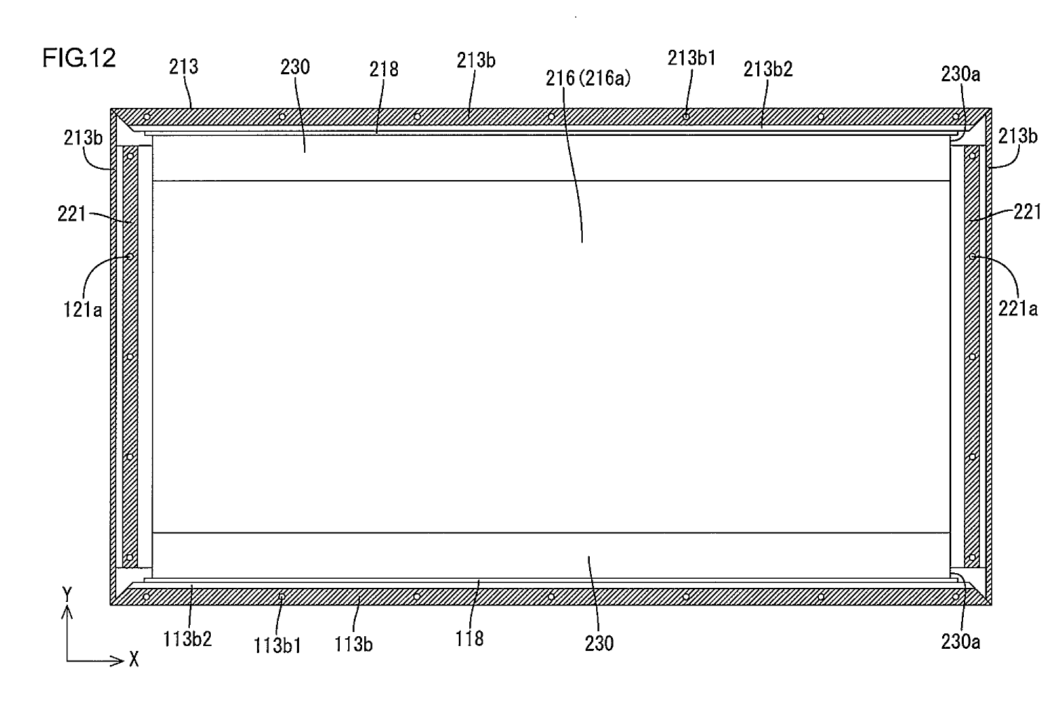

A third embodiment will be described with reference to the drawings. The third embodiment includes a transparent plate 230 having a shape different from the first and second embodiments. Other configurations are similar to the first embodiment and thus configurations, functions, and effects of those will not be described. In FIGS. 11 and 12, portions indicated by numerals including the reference numerals in FIGS. 3 and 7, respectively, with 200 added thereto have the same configurations as the portions indicated by the respective reference numerals in the first embodiment.

As illustrated in FIGS. 11 and 12, a backlight device 212 according to the third embodiment includes two optical members 230, 230 arranged on a light exit surface 216b of a light guide plate 216. The transparent plates 230 have the same shape. Each transparent plate 230 is in contact with an optical member 215 and an edge portion of the light exit surface 216a close to a corresponding light entrance surface 216b. In this configuration, the transparent plate 230 is arranged between the light guide plate 216 and the optical member 215 and thus the light guide plate 216 and the optical member 215 are apart from each other. The transparent plate 230 has thermal conductivity lower than that of the light guide plate 216. Namely, heat around LEDs 217 is less likely to propagate to the optical member 215 compared to a configuration in which the light guide plate 216 and the optical member 215 are in contact with each other. Therefore, the optical member 215 is not or less likely to be wrinkled due to heat around the LEDs 217. Thus, the quality of illumination light, that is, light out of the optical member 215 through the light exit surface 216a, is not or less likely to be degraded.

### Fourth Embodiment

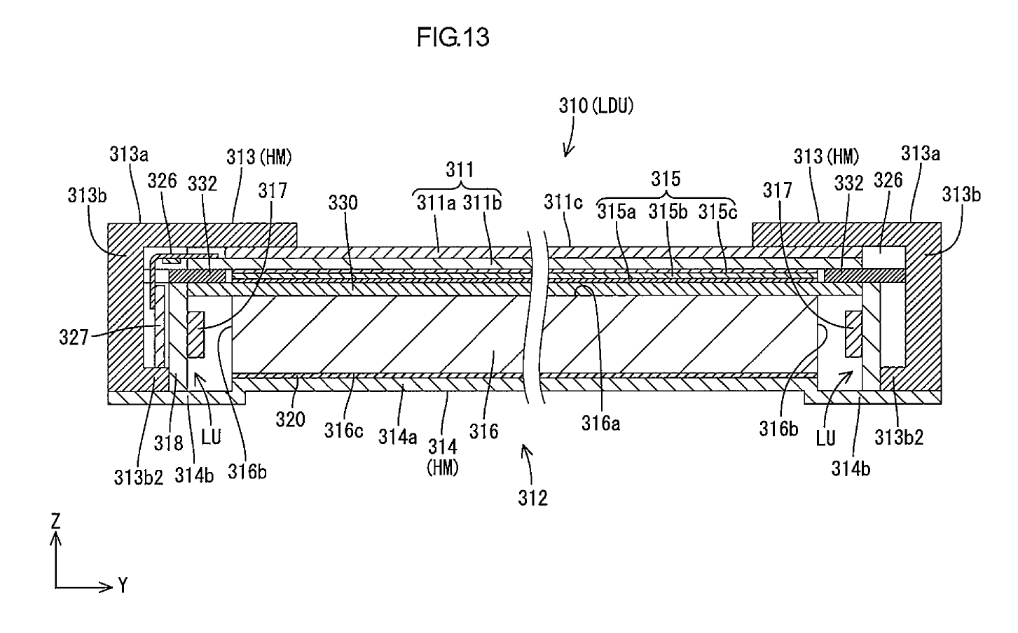

A fourth embodiment will be described with reference to the drawings. The fourth embodiment is different from the first embodiment in terms of including a holding member 332. Other configurations are similar to the first embodiment and thus configurations, functions, and effects of those will not be described. In FIG. 13, portions indicated by numerals including the reference numerals in FIG. 4 with 300 added thereto have the same configurations as the portions indicated by the respective reference numerals in the first embodiment.

As illustrated in FIG. 13, a backlight device 312 according to the fourth embodiment includes the holding member 332. The holding member 332 is a plate member having a frame-like shape. An inner periphery of the holding member 332 is slightly larger in size than an optical member 315. The holding member 332 is placed on a side-surface of each LED board 318 facing the front and surrounds the optical member 315. In the backlight device 312, dimensions of a liquid crystal panel 311 in a plan view are slightly larger than those of the optical member 315 and a light guide plate 316. The holding member 332 is sandwiched between edge portions of the liquid crystal panel 311 and edge portions of the transparent plate 330. The holding member 332 is in contact with the edge portions of the transparent plate 330. Namely, the edge portions of the transparent plate 330 are held with the holding member 332. In this embodiment, because the transparent plate 330 is held with the holding member 332, the transparent plat 330 is held steady. Therefore, the position of the transparent plate 330 is less likely to shift. Even if the transparent plate 330 thermally expands toward the liquid crystal panel 311, the transparent plate 330 is less likely to come close to the optical member 315. Therefore, portions of the liquid crystal panel 311 is not or less likely to be pressed by the light guide plate 316 via the optical member 315. Thus, the quality of illumination light in the liquid crystal display device 310 is not or less likely to be degraded.

The holding member 332 has light blocking properties. The holding member 332 is in contact with the edge portions of the liquid crystal panel 311, namely, the holding member 332 is between LEDs 317 and the respective edge portions of the liquid crystal panel 311. In this configuration, rays of light exiting the LEDs 317 and traveling toward an edge surface of the liquid crystal panel 311 are blocked by the holding member 332. Namely, the rays of light do not or are less likely to enter the liquid crystal panel 311 through the end surface. Therefore, uneven brightness, which may be caused by light entering the liquid crystal panel 311 through the end surface thereof, does not or is less likely to occur on a display surface 311c of the liquid crystal panel 311.

Modifications of the above embodiments will be listed below.

(1) In each of the above embodiments, the configuration includes the transparent plate that is in contact with the light exit surface of the light guide plate and the rear surface of the optical member. In addition to the transparent plate, the configuration can include a member other than the transparent plate arranged between the light guide plate and the optical member as long as the transparent plate is arranged between at least the frame-like portion of the light exit surface, which is the edge area of the light exit surface, and the optical member.

(2) In each of the above embodiments, the transparent plate is made of glass. However, the material of the transparent plate is not limited to glass.

(3) In each of the above embodiments, the liquid crystal display device does not include a cabinet. However, the liquid crystal display device may include a cabinet.

(4) In each of the above embodiments, the extension portions that extend along the long sides of the transparent plate are in contact with the respective mount surfaces of the LED boards. However, the extension portions may be apart from the LED boards. The transparent plate may not include the extension portions and the long side-surfaces of the light guide plate 16 may be aligned with the respective light entrance surfaces of the light guide plate in the Z-axis direction.

(5) In each of the above embodiments, the LED board is directly mounted to the frame and the chassis. However, a heat dissipation member having heat dissipation properties may be disposed between the LED board and the frame and the chassis.

(6) The configuration, arrangement, number, shape, and material of the transparent plate can be altered from those in the above embodiments as appropriate.

(7) In each of the above embodiments, the liquid crystal display device including the liquid crystal panel as the display panel is used. However, the aspect of this invention can be applied to display devices including other types of display panels.

The above embodiments described in detail are only examples and the scope of the claimed invention is not limited to the embodiments. The technical scope of the claimed invention includes various modifications of the above embodiments.

The technical elements described in this specification and the drawings may be used independently or in combination to achieve the technical benefits. The combinations are not limited to those in claims. With the technologies described in this specification and the drawings, multiple objectives may be accomplished at the same time. However, the technical benefits can be achieved by accomplishing even only one of the objectives.

### EXPLANATION OF SYMBOLS

TV: a television device, LDU: liquid crystal display unit, PWB: power source board, MB: main board, CTB: control board, CV: cover, ST: stand, LU: LED unit, 10, 110, 210, 310: liquid crystal display device, 11, 111, 211, 311: liquid crystal panel, 12, 112, 212, 312: backlight device, 13, 113, 213, 313: frame, 14, 114, 214, 314: chassis, 15, 115, 215, 315: optical member, 16, 116, 216, 316: light guide plate, 16a, 116a, 216a, 316a: light exit surface, 16b, 116b, 216b, 316b: light entrance surface, 17, 117, 217, 317: LED, 18, 118, 218, 318: LED board, 20, 120, 220: reflection sheet, 30, 130, 230, 330: transparent plate, 30a: extension portion, 332: holding member.

1. A lighting device comprising:
a light source;
a light guide plate including a plate surface configured as a light exit surface and at least one side-surface configured as a light entrance surface, the light entrance surface facing the light source and being configured to guide light from the light source toward the light exit surface;
an optical member arranged adjacent to the light exit surface of the light guide plate; and
a transparent plate having transparency and having thermal conductivity lower than thermal conductivity of the light guide plate and arranged between the optical member and at least one edge portion of the light exit surface close to the light entrance surface.

2. The lighting device according to claim 1, wherein the transparent plate is in contact with the optical member and has rigidity higher than rigidity of the light guide plate.

3. The lighting device according to claim 1, wherein the transparent plate is in contact with the light exit surface of the light guide plate and has a thermal expansion coefficient lower than a thermal expansion coefficient of the light guide plate.

4. The lighting device according to claim 1, wherein the transparent plate is arranged between a frame-like portion of the light exit surface including at least an edge area of the light exit surface and the optical member.

5. The lighting device according to claim 4, wherein the transparent plate is arranged between the light exit surface and the optical member for an entire area of the light exit surface.

6. The lighting device according to claim 1, further comprising a light source board, wherein
the light source includes a plurality of light sources arranged on the light source board, and
at least a portion of the side surface of the transparent plate extends to the light source board and is in contact with a plate surface of the light source board on which the light sources are arranged.

7. A display device comprising:
the lighting device according to claim 1; and
a display panel arranged on an opposite side of the optical member from the transparent plate and configured to display an image using light from the light source; and
a holding member having a frame-like shape surrounding the optical member, the holding member being arranged between the transparent plate and the display panel and in contact with an edge portion of the transparent plate to hold the transparent plate.

8. The display device according to claim 7, wherein the holding member having a light blocking property is positioned between the light sources and an edge portion of the display panel and in contact with at least one edge portion of an opposite surface of the display panel from the display surface.

9. The display device according to claim 7, wherein the display panel is a liquid crystal display panel including liquid crystals.

10. A television device comprising the display device according to claim 7.
